(19) United States
(12) Patent Application Publication
(10) Pub. No.: US 2026/0057842 A1
(43) Pub. Date: Feb. 26, 2026

(54) DISPLAY DEVICE

(71) Applicant: Samsung Display Co., LTD., Yongin-si (KR)

(72) Inventors: Geum Ju MOON, Yongin-si (KR); Sung Min SON, Yongin-si (KR); Min Ji KIM, Yongin-si (KR); Won Jun LEE, Yongin-si (KR)

(73) Assignee: Samsung Display Co., LTD., Yongin-si (KR)

(21) Appl. No.: 19/210,015

(22) Filed: May 16, 2025

(30) Foreign Application Priority Data
Aug. 23, 2024 (KR) 10-2024-0113313

(51) Int. Cl. G09G 3/3266; G09G 3/32

(52) U.S. Cl. CPC G09G 3/3266; G09G 3/32; G09G 2300/0819; G09G 2310/0267; G09G 2310/08; G09G 2320/0247; G09G 2330/021

(57) ABSTRACT

A display device includes a display panel in which a plurality of pixels are arranged in a display area to display an image; and a gate driver supplying gate scan signals to the plurality of pixels in units of horizontal lines, wherein the plurality of pixels include: a first transistor connected between a driving voltage line and a second node; a sixth transistor connected between the second node and a common voltage line; a light emitting element connected between the sixth transistor and the common voltage line; and a fourth transistor connected between the second node and an initialization voltage line, and the gate driver generates another gate scan signal by delaying a phase of one of the gate scan signals, and supplies the another gate scan signal of which the phase is delayed to the plurality of pixels.

### CROSS-REFERENCE TO RELATED APPLICATION

This application claims priority to and benefits of Korean Patent Application No. 10-2024-0113313 under 35 U.S.C. 119, filed on Aug. 23, 2024, in the Korean Intellectual Property Office (KIPO), the entire contents of which are incorporated herein by reference.

### BACKGROUND

### 1. Technical Field

The disclosure relates to a display device.

### 2. Description of the Related Art

As an information society develops, the demand for a display device for displaying an image is increasing in various forms. For example, display devices are applied to various electronic devices such as smartphones, digital cameras, laptop computers, navigation devices, and smart televisions.

The display device may be a flat panel display device such as a liquid crystal display device, a field emission display device, an organic light emitting display device, or the like. Among these flat panel display devices, the organic light emitting display device includes a light emitting element in which luminance of each pixel changes depending on the current, for example, an organic light emitting diode. Accordingly, the organic light emitting display device may display an image without a separate light emitting element that provides light to a display panel.

### SUMMARY

Aspects of the disclosure provide a display device capable of reducing leakage current and flicker for each pixel of a display panel and accurately expressing an image corresponding to black gradation.

Aspects of the disclosure also provide a display device capable of improving a transistor arrangement structure of a pixel circuit for each pixel and modulating the delay period and phase of one gate scan signal among gate scan signals supplied to pixel circuits to supply the modulated gate scan signal as another gate scan signal.

However, the disclosure is not restricted to those set forth herein. The above and other aspects of the disclosure will become more apparent to one of ordinary skill in the art to which the disclosure pertains by referencing the detailed description of the disclosure given below.

According to an embodiment of the disclosure, a display device may include a display panel in which a plurality of pixels are arranged in a display area to display an image, and a gate driver supplying gate scan signals to the plurality of pixels in units of horizontal lines. The plurality of pixels may include a first transistor connected between a driving voltage line and a second node, a sixth transistor connected between the second node and a common voltage line, a light emitting element connected between the sixth transistor and the common voltage line, and a fourth transistor connected between the second node and an initialization voltage line. The gate driver may generate another gate scan signal by delaying a phase of one of the gate scan signals, and supply the another gate scan signal of which the phase is delayed to the plurality of pixels.

According to an embodiment of the disclosure, the plurality of pixels may further include a second transistor connected between a data line and a first node, a third transistor connected between a third node and the second node, a fifth transistor connected between the driving voltage line and the first node, a seventh transistor connected between a bias voltage line and the first node, and an eighth transistor connected between an anode electrode of the light emitting element and a light emitting initialization line. The first transistor may be connected between the first node and the second node, and a gate electrode of the first transistor may be connected to the third node.

According to an embodiment of the disclosure, the first transistor, the second transistor, the fourth transistor, the fifth transistor, the sixth transistor, the seventh transistor, and the eighth transistor may be p-type transistors, and the third transistor may be an n-type transistor.

According to an embodiment of the disclosure, the plurality of pixels may further include a write gate line connected to a gate electrode of the second transistor, a compensation gate line connected to a gate electrode of the third transistor, an initialization gate line connected to a gate electrode of the fourth transistor, a light emitting line connected to gate electrodes of the fifth transistor and the sixth transistor, a bias gate line connected to gate electrodes of the seventh transistor and the eighth transistor, and a capacitor connected between the driving voltage line and the third node.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, and delay a phase of the bias gate signal for a period of time and supply the bias gate signal of which the phase is delayed as an initialization gate signal to the initialization gate line.

According to an embodiment of the disclosure, the gate driver may generate and transmit the compensation gate signal and the bias gate signal at an active level, in a first period among periods for driving the plurality of pixels, transmit the initialization gate signal at an active level and the compensation gate signal at the active level, in a second period, generate and transmit the compensation gate signal at the active level and the write gate signal at an active level, in a third period, generate and transmit the bias gate signal at the active level, in a fourth period, transmit the initialization gate signal at the active level, in a fifth period, and generate and transmit the light emitting signal at an active level, in a sixth period.

According to an embodiment of the disclosure, the first transistor, the second transistor, the fifth transistor, the sixth transistor, the seventh transistor, and the eighth transistor may be p-type transistors, and the third transistor and the fourth transistor may be n-type transistors.

According to an embodiment of the disclosure, the plurality of pixels may further include a write gate line connected to a gate electrode of the second transistor, a compensation gate line connected to a gate electrode of the third transistor, an initialization gate line connected to a gate electrode of the fourth transistor, a light emitting line connected to gate electrodes of the fifth transistor and the sixth transistor, a bias gate line connected to gate electrodes of the seventh transistor and the eighth transistor, and a capacitor connected between the driving voltage line and the third node.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, and delay the bias gate signal for a period of time, invert a phase of the bias gate signal of which is delayed, and supply the bias gate signal of which is delayed and inverted as an initialization gate signal to the initialization gate line.

According to an embodiment of the disclosure, the first transistor, the second transistor, the fifth transistor, the sixth transistor, and the seventh transistor may be p-type transistors, and the third transistor, the fourth transistor, and the eighth transistor may be n-type transistors.

According to an embodiment of the disclosure, the plurality of pixels may further include a write gate line connected to a gate electrode of the second transistor, a compensation gate line connected to a gate electrode of the third transistor, an initialization gate line connected to a gate electrode of the fourth transistor, a light emitting line connected to gate electrodes of the fifth transistor and the sixth transistor, a bias gate line connected to a gate electrode of the seventh transistor, an inverted bias gate line connected to a gate electrode of the eighth transistor, and a capacitor connected between the driving voltage line and the third node.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, invert a phase of the bias gate signal and transmit the bias gate signal to the inverted bias gate line, and delay the bias gate signal for a period of time, inverts a phase of the bias gate signal of which is delayed, and supply the bias gate signal of which is delayed and inverted as an initialization gate signal to the initialization gate line.

According to another embodiment of the disclosure, a display device may include a display panel in which a plurality of pixels are arranged in a display area to display an image, and a gate driver supplying gate scan signals to the plurality of pixels in units of horizontal lines. The gate driver may generate another gate scan signal by delaying a phase of one of the gate scan signals, and supply the another gate scan signal of which the phase is delayed to the plurality of pixels. The plurality of pixels may include a first transistor connected between a driving voltage line and a second node, a second transistor connected between a data line and a first node, a third transistor connected between a third node and the second node, a fourth transistor connected between the second node and an initialization voltage line, a fifth transistor connected between the driving voltage line and the first node, a sixth transistor connected between the second node and a common voltage line, a seventh transistor connected between a bias voltage line and the first node, an eighth transistor connected between an anode electrode of a light emitting element and a light emitting initialization line, and the light emitting element connected between the sixth transistor and the common voltage line.

According to an embodiment of the disclosure, the plurality of pixels may further include a write gate line connected to a gate electrode of the second transistor, a compensation gate line connected to a gate electrode of the third transistor, an initialization gate line connected to a gate electrode of the fourth transistor, a light emitting line connected to gate electrodes of the fifth transistor and the sixth transistor, a bias gate line connected to gate electrodes of the seventh transistor and the eighth transistor, and a capacitor connected between the driving voltage line and the third node.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, and delay a phase of the bias gate signal for a period of time and supply the bias gate signal as an initialization gate signal to the initialization gate line.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, and delay the bias gate signal for a period of time, invert a phase of the bias gate signal of which is delayed, and supply the bias gate signal of which is delayed and inverted as an initialization gate signal to the initialization gate line.

According to an embodiment of the disclosure, the plurality of pixels may further include a write gate line connected to a gate electrode of the second transistor, a compensation gate line connected to a gate electrode of the third transistor, an initialization gate line connected to a gate electrode of the fourth transistor, a light emitting line connected to gate electrodes of the fifth transistor and the sixth transistor, a bias gate line connected to a gate electrode of the seventh transistor, an inverted bias gate line connected to a gate electrode of the eighth transistor, and a capacitor connected between the driving voltage line and the third node.

According to an embodiment of the disclosure, the gate driver may transmit a write gate signal to the write gate line, transmit a compensation gate signal to the compensation gate line, transmit a bias gate signal to the bias gate line, transmit a light emitting signal to the light emitting line, and delay the bias gate signal for a period of time, invert a phase of the bias gate signal of which is delayed, and supply the bias gate signal of which is delayed and inverted as an initialization gate signal to the initialization gate line.

According to an embodiment of the disclosure, an electronic device including a display device may include a display panel in which a plurality of pixels are arranged in a display area to display an image, and a gate driver supplying gate scan signals to the plurality of pixels in units of horizontal lines. The plurality of pixels may include a first transistor connected between a driving voltage line and a second node, a sixth transistor connected between the second node and a common voltage line, a light emitting element connected between the sixth transistor and the common voltage line, and a fourth transistor connected between the second node and an initialization voltage line. The gate driver may generate another gate scan signal by delaying a phase of one of the gate scan signals, and supply the another gate scan signal of which the phase is delayed to the plurality of pixels.

According to an embodiment, the leakage current and flicker for each pixel of the display panel may be minimized, and the effect of reducing power consumption of the display device may be increased.

Further, according to an embodiment, even if the brightness of the image rapidly changes from white gradation to black gradation, the image corresponding to the black gradation may be accurately expressed.

Further, according to an embodiment, the circuit structure of the gate driver may be simplified, and the size and layout area of the gate driver may be reduced.

However, the effects of the embodiments are not restricted to the one set forth herein. The above and other effects of the embodiments will become more apparent to one of daily skill in the art to which the embodiments pertain by referencing the claims.

### BRIEF DESCRIPTION OF THE DRAWINGS

The above and other aspects and features of the disclosure will become more apparent by describing in detail embodiments thereof with reference to the attached drawings, in which:

FIG. 1 is a perspective view illustrating a display device according to an embodiment;

FIG. 2 is a schematic cross-sectional view illustrating the display device according to an embodiment;

FIG. 3 is a plan view illustrating a display unit of the display device according to an embodiment;

FIG. 4 is a schematic block diagram illustrating a display panel and a display driver according to an embodiment;

FIG. 5 is a schematic diagram of an equivalent circuit of one pixel of a display device according to a first embodiment;

FIG. 6 is a schematic timing diagram of a light emitting signal, a compensation gate signal, a write gate signal, a bias gate signal, and a modulated initialization gate signal of FIG. 5;

FIG. 7 is a schematic diagram for describing an operation of the pixel of FIG. 5 in a first period of FIG. 6;

FIG. 8 is a schematic diagram for describing an operation of the pixel of FIG. 5 in a second period of FIG. 6;

FIG. 9 is a schematic diagram for describing an operation of the pixel of FIG. 5 in a third period of FIG. 6;

FIG. 10 is a schematic diagram for describing an operation of the pixel of FIG. 5 in a fourth period of FIG. 6;

FIG. 11 is a schematic diagram for describing an operation of the pixel of FIG. 5 in a fifth period of FIG. 6;

FIG. 12 is a schematic diagram for describing an operation of the pixel of FIG. 5 in a sixth period of FIG. 6;

FIG. 13 is a schematic diagram of an equivalent circuit of one pixel of a display device according to a second embodiment;

FIG. 14 is a schematic timing diagram of a light emitting signal, a compensation gate signal, a write gate signal, a bias gate signal, and a modulated initialization gate signal of FIG. 13;

FIG. 15 is a schematic diagram of an equivalent circuit of one pixel of a display device according to a third embodiment; and

FIG. 16 is a schematic timing diagram of a light emitting signal, a compensation gate signal, a write gate signal, a bias gate signal, a modulated bias control signal, and a modulated initialization gate signal of FIG. 15.

### DETAILED DESCRIPTION OF THE EMBODIMENTS

The disclosure will now be described more fully hereinafter with reference to the accompanying drawings, in which embodiments of the disclosure are shown. This disclosure may, however, be embodied in different forms and should not be construed as limited to the embodiments set forth herein. Rather, these embodiments are provided so that this disclosure will be more thorough and complete, and will fully convey the scope of the disclosure to those skilled in the art.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element. The same reference numbers indicate the same components throughout the specification.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

Each of the features of the various embodiments of the disclosure may be combined or combined with each other, in part or in whole, and technically various interlocking and driving are possible. Each embodiment may be implemented independently of each other or may be implemented together in an association.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

Hereinafter, embodiments will be described with reference to the accompanying drawings.

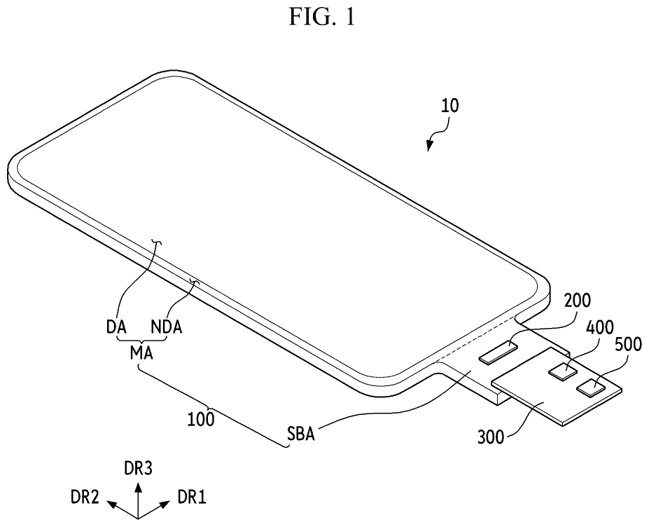

FIG. 1 is a perspective view illustrating a display device according to an embodiment.

Referring to FIG. 1, a display device 10 may be applied to portable electronic devices such as a mobile phone, a smartphone, a tablet personal computer (PC), a mobile communication terminal, an electronic notebook, an electronic book, a portable multimedia player (PMP), navigation, and an ultra mobile PC (UMPC). For example, the display device 10 may be applied to a display unit of a television, a laptop computer, a monitor, a billboard, or the Internet of Things (IOT). For example, the display device 10 may be applied to a wearable device such as a smart watch, a watch phone, a glasses-type display, and a head mounted display (HMD).

The display device 10 may be formed in a planar shape similar to a quadrangle. For example, the display device 10 may have a planar shape similar to a quadrangle having a short side in a first direction DR1 and a long side in a second direction DR2. A corner where the short side in the first direction DR1 and the long side in the second direction DR2 meet may be rounded to have a curvature or may be formed at a right angle. The planar shape of the display device 10 is not limited to the quadrangle, and may be formed similarly to other polygons, circles, or ovals.

The display device 10 may include a display panel 100, a display driver 200, a circuit board 300, a touch driver 400, and a power supply unit 500.

The display panel 100 may include a main area MA and a sub-area SBA.

The main area MA may include a display area DA including pixels displaying an image, and a non-display area NDA disposed adjacent to the display area DA. The display area DA may emit light from multiple light emitting areas or multiple opening areas. For example, the display panel 100 may include a pixel circuit including switching elements, a pixel defining layer defining the light emitting areas or the opening areas, and a self-light emitting element.

For example, the self-light emitting element may include at least one of an organic light emitting diode (LED) including an organic light emitting layer, a quantum dot LED including a quantum dot light emitting layer, an inorganic LED including an inorganic semiconductor, and a micro LED, but the disclosure is not limited thereto.

The non-display area NDA may be an area outside the display area DA. The non-display area NDA may be defined as an edge area of the main area MA of the display panel 100. The non-display area NDA may include a gate driver (not illustrated) supplying gate signals to gate lines, and fan-out lines (not illustrated) connecting the display driver 200 and the display area DA.

The sub-area SBA may extend from a side of the main area MA. The sub-area SBA may include a flexible material that may be bent, folded, rolled, or the like. For example, in case that the sub-area SBA is bent, the sub-area SBA may overlap the main area MA in a thickness direction (e.g., a third direction DR3). The sub-area SBA may include the display driver 200 and a pad portion connected to the circuit board 300. In another embodiment, the sub-area SBA may be omitted, and the display driver 200 and the pad portion may be disposed in the non-display area NDA.

The display driver 200 may output signals and voltages for driving the display panel 100. The display driver 200 may supply data voltages to data lines. The display driver 200 may supply a voltage to a power line and may supply a gate control signal to a gate driver. The display driver 200 may be formed as an integrated circuit (IC) and mounted on the display panel 100 by a chip on glass (COG) method, a chip on plastic (COP) method, or an ultrasonic bonding method. For example, the display driver 200 may be disposed in the sub-area SBA, and may overlap the main area MA in the thickness direction (the third direction DR3) by bending of the sub-area SBA. In another embodiment, the display driver 200 may be mounted on the circuit board 300.

The circuit board 300 may be attached onto the pad portion of the display panel 100 using an anisotropic conductive film (ACF). Lead lines of the circuit board 300 may be electrically connected to the pad portion of the display panel 100. The circuit board 300 may be a flexible film such as a flexible printed circuit board, a printed circuit board, or a chip on film.

The touch driver 400 may be mounted on the circuit board 300. The touch driver 400 may be electrically connected to a touch sensing unit of the display panel 100. The touch driver 400 may supply a touch driving signal to multiple touch electrodes of the touch sensing unit, and may sense an amount of change in capacitance between the touch electrodes. For example, the touch driving signal may be a pulse signal having a frequency. The touch driver 400 may calculate whether an input is made and input coordinates based on the amount of change in capacitance between the touch electrodes. The touch driver 400 may be formed as an integrated circuit (IC).

The power supply unit 500 may be disposed on the circuit board 300, and may supply a voltage to the display driver 200 and the display panel 100. The power supply unit 500 may generate a driving voltage to supply the driving voltage to a driving voltage line VDL, generate an initialization voltage to supply the initialization voltage to an initialization voltage line, generate a bias voltage to supply the bias voltage to a bias voltage line, and generate a common voltage to supply the common voltage to a common voltage line. The common voltage of the common voltage line may be supplied to a cathode electrode common to light emitting elements ED of multiple pixels PX. The driving voltage may be a high potential voltage for driving the light emitting element ED, and the common voltage may be a low potential voltage for driving the light emitting element ED.

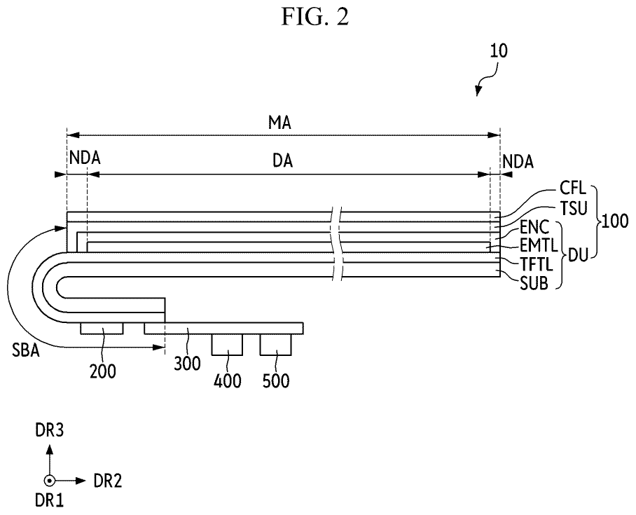

FIG. 2 is a schematic cross-sectional view illustrating the display device according to an embodiment.

Referring to FIG. 2, the display panel 100 may include a display unit DU, a touch sensing unit TSU, and a color filter layer CFL. The display unit DU may include a substrate SUB, a thin film transistor layer TFTL, a light emitting element layer EMTL, and an encapsulation layer ENC.

The substrate SUB may be a base substrate or a base member. The substrate SUB may be a flexible substrate that may be bent, folded, rolled, or the like. For example, the substrate SUB may include a polymer resin including polyimide, but the disclosure is not limited thereto. In another embodiment, the substrate SUB may include a glass material or a metal material.

The thin film transistor layer TFTL may be disposed on the substrate SUB. The thin film transistor layer TFTL may include multiple thin film transistors constituting a pixel circuit of pixels. The thin film transistor layer TFTL may further include gate lines, data lines, power lines, gate control lines, fan-out lines connecting the display driver 200 and the data lines, and lead lines connecting the display driver 200 and the pad portion. Each of the thin film transistors may include a semiconductor area, a source electrode, a drain electrode, and a gate electrode. For example, in case that the gate driver is formed on a side of the non-display area NDA of the display panel 100, the gate driver may include thin film transistors.

The thin film transistor layer TFTL may be disposed in the display area DA, the non-display area NDA, and the sub-area SBA. The thin film transistors, the gate lines, the data lines, and the power lines of each of the pixels of the thin film transistor layer TFTL may be disposed in the display area DA. The gate control lines and the fan-out lines of the thin film transistor layer TFTL may be disposed in the non-display area NDA. The lead lines of the thin film transistor layer TFTL may be disposed in the sub-area SBA.

The light emitting element layer EMTL may be disposed on the thin film transistor layer TFTL. The light emitting element layer EMTL may include multiple light emitting elements ED in which a first electrode (hereinafter, referred to as an anode electrode), a light emitting layer, and a second electrode (hereinafter, referred to as a cathode electrode) are sequentially stacked to emit light, and a pixel defining layer defining pixels. The light emitting elements ED of the light emitting element layer EMTL may be disposed in the display area DA.

For example, the light emitting layer may be an organic light emitting layer including an organic material. The light emitting layer may include a hole transporting layer, an organic light emitting layer, and an electron transporting layer. In case that the anode electrode receives a voltage through the thin film transistor of the thin film transistor layer TFTL, and the cathode electrode receives a cathode voltage, holes and electrons may move to the organic light emitting layer through the hole transporting layer and the electron transporting layer, respectively, and may recombine in the organic light emitting layer to emit light.

In another embodiment, the light emitting elements ED may include a quantum dot light emitting diode including a quantum dot light emitting layer, an inorganic light emitting diode including an inorganic semiconductor, or a micro light emitting diode.

The encapsulation layer ENC may cover an upper surface and side surfaces of the light emitting element layer EMTL, and may protect the light emitting element layer EMTL. The encapsulation layer ENC may include at least one inorganic layer and at least one organic layer for encapsulating the light emitting element layer EMTL.

The touch sensing unit TSU may be disposed on the encapsulation layer ENC. The touch sensing unit TSU may include multiple touch electrodes for sensing a user's touch in a capacitance method, and touch lines connecting the touch electrodes and the touch driver 400. For example, the touch sensing unit TSU may sense the user's touch in a mutual capacitance method or a self-capacitance method.

In another embodiment, the touch sensing unit TSU may be disposed on a separate substrate disposed on the display unit DU. The substrate supporting the touch sensing unit TSU may be a base member that encapsulates the display unit DU.

The touch electrodes of the touch sensing unit TSU may be disposed in a touch sensor area in the display area DA. The touch lines of the touch sensing unit TSU may be disposed in a touch peripheral area in the non-display area NDA.

The color filter layer CFL may be disposed on the touch sensing unit TSU. The color filter layer CFL may include multiple color filters corresponding to each of the light emitting areas. Each of the color filters may selectively transmit light of a wavelength and block or absorb light of other wavelengths. The color filter layer CFL may absorb a portion of light introduced from the outside of the display device 10 to reduce reflected light caused by external light. Therefore, the color filter layer CFL may prevent color distortion caused by reflection of external light.

As the color filter layer CFL is directly disposed on the touch sensing unit TSU, the display device 10 may not require a separate substrate for the color filter layer CFL. Therefore, a thickness of the display device 10 may be relatively reduced.

The sub-area SBA of the display panel 100 may extend from a side of the main area MA. The sub-area SBA may include a flexible material that may be bent, folded, rolled, or the like. For example, in case that the sub-area SBA is bent, the sub-area SBA may overlap the main area MA in the thickness direction (the third direction DR3). The sub-area SBA may include a pad portion electrically connected to the display driver 200 and the circuit board 300.

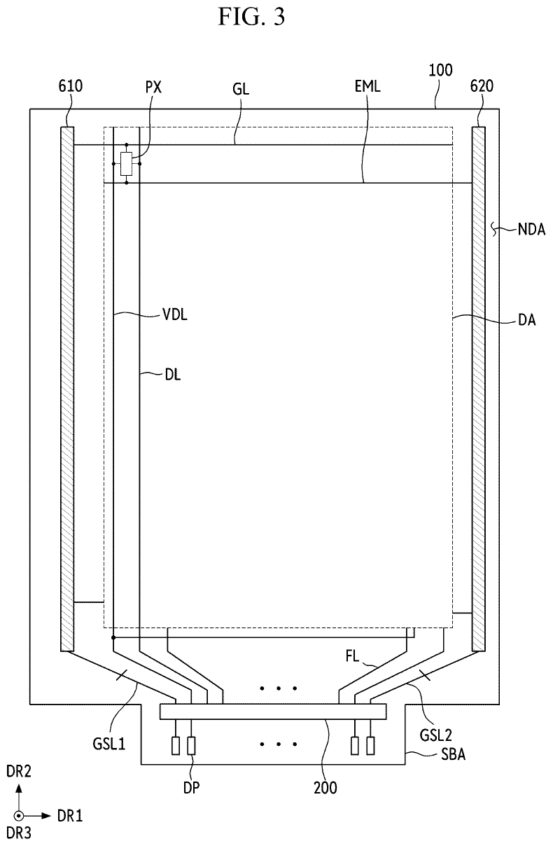

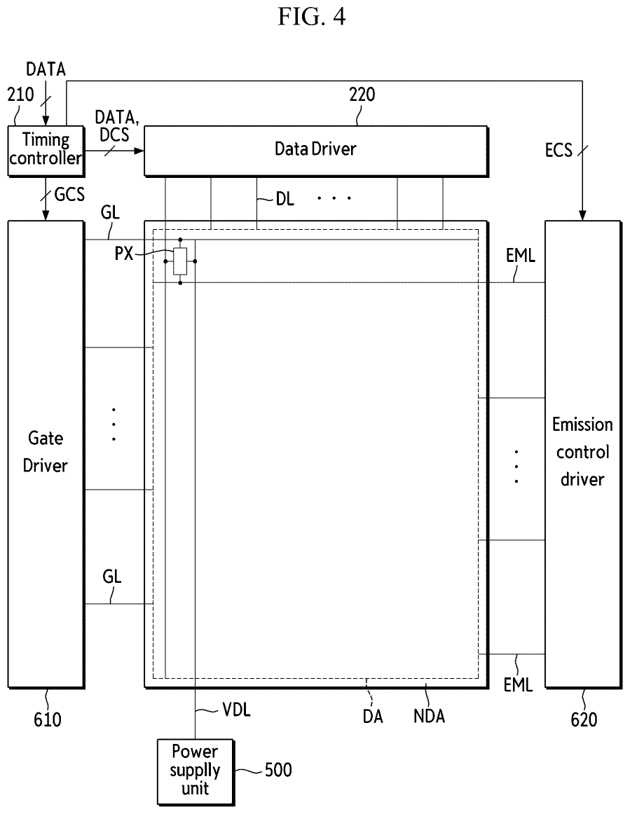

FIG. 3 is a plan view illustrating a display unit of the display device according to an embodiment. FIG. 4 is a schematic block diagram illustrating a display panel and a display driver according to an embodiment.

Referring to FIGS. 3 and 4, the display panel 100 may include a display area DA and a non-display area NDA.

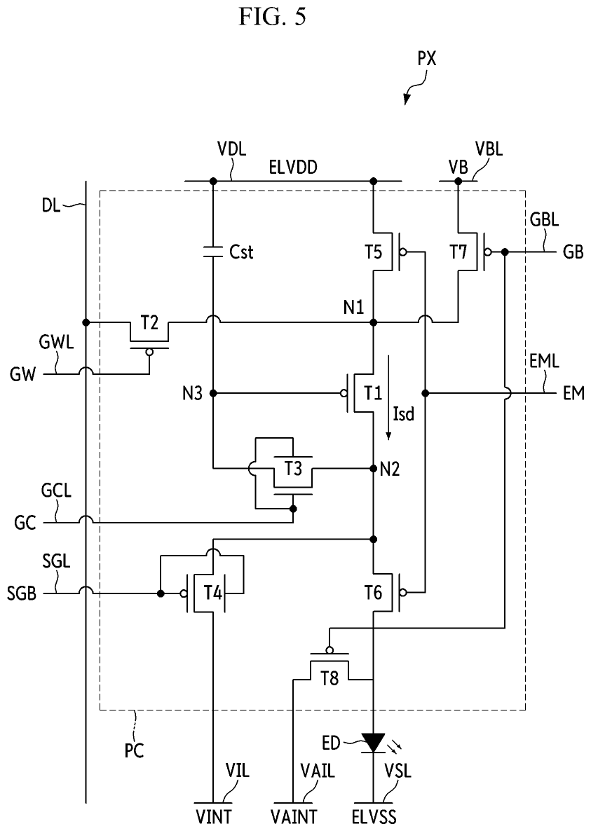

The display area DA may include multiple pixels PX, multiple driving voltage lines VDL connected to the pixels PX, multiple gate lines GL of multiple common voltage lines (VSL in FIG. 5), multiple light emitting lines EML, and multiple data lines DL.

Each of the pixels PX may be connected to a gate line GL, a data line DL, a light emitting line EML, a driving voltage line VDL, and a common voltage line VSL. Each of the pixels PX may include at least one transistor, a light emitting element ED, and a capacitor.

The gate lines GL may extend in the first direction DR1 and may be spaced apart from each other in the second direction DR2 intersecting the first direction DR1. The gate lines GL may be arranged in the second direction DR2. The gate lines GL may sequentially supply gate signals to the pixels PX.

The light emitting lines EML may extend in the first direction DR1 and may be spaced apart from each other in the second direction DR2. The light emitting lines EML may be arranged in the second direction DR2. The light emitting lines EML may sequentially supply light emitting signals to the pixels PX.

The data lines DL may extend in the second direction DR2 and may be spaced apart from each other in the first direction DR1. The data lines DL may be arranged in the first direction DR1. The data lines DL may supply data voltages to the pixels PX. The data voltage may determine luminance of each of the pixels PX.

The driving voltage lines VDL may extend in the second direction DR2 and may be spaced apart from each other in the first direction DR1. The driving voltage lines VDL may be arranged in the first direction DR1. The driving voltage lines VDL may supply driving voltages to the pixels PX. The driving voltage may be a high potential voltage for driving light emitting element ED.

The non-display area NDA may surround the display area DA. The non-display area NDA may include a gate driver 610, an emission control driver 620, fan-out lines FL, a first gate control line GSL1, and a second gate control line GSL2.

The fan-out lines FL may extend from the display driver 200 to the display area DA. The fan-out lines FL may supply data voltages received from the display driver 200 to the data lines DL.

The first gate control line GSL1 may extend from the display driver 200 to the gate driver 610. The first gate control line GSL1 may supply a gate control signal GCS received from the display driver 200 to the gate driver 610.

The second gate control line GSL2 may extend from the display driver 200 to the emission control driver 620. The second gate control line GSL2 may supply an emission control signal ECS received from the display driver 200 to the emission control driver 620.

The sub-area SBA may extend from a side of the non-display area NDA. The sub-area SBA may include the display driver 200 and the pad portion DP. The pad portion DP may be disposed closer to an edge of a side of the sub-area SBA than the display driver 200. The pad portion DP may be electrically connected to the circuit board 300 through an anisotropic conductive film ACF.

The display driver 200 may include a timing controller 210 and a data driver 220.

The timing controller 210 may receive digital video data DATA and timing signals input from the circuit board 300. Based on the timing signals, the timing controller 210 may control an operation timing of the data driver 220 by generating a data control signal DCS, control an operation timing of the gate driver 610 by generating a gate control signal GCS, and control an operation timing of the emission control driver 620 by generating the emission control signal ECS. The timing controller 210 may supply the gate control signal GCS to the gate driver 610 through the first gate control line GSL1. The timing controller 210 may supply the emission control signal ECS to the emission control driver 620 through the second gate control line GSL2. The timing controller 210 may supply the digital video data DATA and the data control signal DCS to the data driver 220.

The data driver 220 may convert the digital video data DATA into analog data voltages and supply the analog data voltages to the data lines DL through the fan-out lines FL. The gate signals of the gate driver 610 may select the pixels PX to which the data voltage is supplied, and the selected pixels PX may receive the data voltage through the data lines DL.

The power supply unit 500 may be disposed on the circuit board 300, and may supply a voltage to the display driver 200 and the display panel 100. The power supply unit 500 may generate a driving voltage to supply the driving voltage to the driving voltage line VDL, generate an initialization voltage to supply the initialization voltage to an initialization voltage line VIL, and generate a common voltage to supply the common voltage to the cathode electrode common to the light emitting elements ED of the pixels.

The gate driver 610 may be disposed outside of a side of the display area DA or on a side of the non-display area NDA, and the emission control driver 620 may be disposed outside of another side of the display area DA or on another side of the non-display area NDA, but the disclosure is not limited thereto. In another embodiment, the gate driver 610 and the emission control driver 620 may be disposed on either a side or another side of the non-display area NDA. In an embodiment, the gate driver 610 and the emission control driver 620 may be integral with each other. For example, the gate driver 610 and the emission control driver 620 may be formed as a one chip type.

The gate driver 610 may include multiple transistors that generate gate signals based on the gate control signal GCS. The emission control driver 620 may include multiple transistors that generate light emitting signals based on the emission control signal ECS. For example, the transistors of the gate driver 610, the transistors of the emission control driver 620, and the transistors of each of the pixels PX may be formed on a same layer. The gate driver 610 may supply the gate signals to the gate lines GL, and the emission control driver 620 may supply the light emitting signals to the light emitting lines EML.

FIG. 5 is a schematic diagram of an equivalent circuit of one pixel of a display device according to a first embodiment.

As illustrated in FIG. 5, the pixel PX may be connected to a write gate line GWL, a compensation gate line GCL, an initialization gate line SGL, a bias gate line GBL, a light emitting line EML, a data line DL, a driving voltage line VDL, a common voltage line VSL, an initialization voltage line VIL, a light emitting initialization line VAIL, and a bias voltage line VBL.

The pixel PX may include a pixel circuit PC and a light emitting element ED. The pixel circuit PC may include a first transistor T1, a second transistor T2, a third transistor T3, a fourth transistor T4, a fifth transistor T5, a sixth transistor T6, a seventh transistor T7, an eighth transistor T8, and a capacitor Cst.

The first transistor T1 may include a gate electrode, a source electrode, and a drain electrode. The first transistor T1 may control a source-drain current (hereinafter, referred to as a driving current) according to a data voltage applied to the gate electrode thereof. A driving current (e.g., Isd) flowing through a channel region of the first transistor T1 may be proportional to a square of a difference between a voltage Vsg between the source electrode and the gate electrode of the first transistor T1 and a threshold voltage Vth (Isd=k×(Vsg−Vth)²). k may be a proportional coefficient determined by a structure and physical characteristics of the first transistor T1, Vsg may be a source-gate voltage of the first transistor T1, and Vth may be a threshold voltage of the first transistor T1.

The light emitting element ED may emit light by receiving the driving current Isd. The amount of light emitted from or luminance of the light emitting element ED may be proportional to the amount of driving current Isd.

The light emitting element ED may be an organic light emitting diode including an anode electrode, a cathode electrode, and an organic light emitting layer disposed between these electrodes (i.e., the anode electrode and the cathode electrode). In another embodiment, the light emitting element ED may be an inorganic light emitting element ED including an anode electrode, a cathode electrode, and an inorganic semiconductor disposed between these electrodes (i.e., the anode electrode and the cathode electrode). In another embodiment, the light emitting element ED may be a quantum dot light emitting element ED including an anode electrode, a cathode electrode, and a quantum dot light emitting layer disposed between these electrodes (i.e., the anode electrode and the cathode electrode). In another embodiment, the light emitting element ED may be a micro light emitting diode.

The anode electrode of the light emitting element ED may be electrically connected to a second node N2. The anode electrode of the light emitting element ED may be connected to the second node N2 through the sixth transistor T6. The cathode electrode of the light emitting element ED may be connected to the common voltage line VSL. The cathode electrode of the light emitting element ED may receive a common voltage ELVSS (e.g., a low potential voltage) from the common voltage line VSL.

The second transistor T2 may be turned on by the write gate signal GW from the write gate line GWL to electrically connect the data line DL and a first node N1, which is connected to the source electrode of the first transistor T1. The second transistor T2 may be turned on by the first gate signal, thereby supplying the data voltage to the first node N1. A gate electrode of the second transistor T2 may be electrically connected to the write gate line GWL, a source electrode of the second transistor T2 may be electrically connected to the data line DL, and a drain electrode of the second transistor T2 may be electrically connected to the first node N1.

The third transistor T3 may be turned on by a compensation gate signal GC from the compensation gate line GCL to electrically connect the second node N2, which is connected to the drain electrode of the first transistor T1, and a third node N3, which is connected to the gate electrode of the first transistor T1. The third transistor T3 may be connected between the third node N3 and the second node N2. For example, a gate electrode of the third transistor T3 may be electrically connected to the compensation gate line GCL, a source electrode of the third transistor T3 may be electrically connected to the third node N3, and a drain electrode of the third transistor T3 may be electrically connected to the second node N2. The third transistor T3 may be turned on by a second gate signal of the compensation gate line GCL to electrically connect the second node N2, which is connected to the drain electrode of the first transistor T1, and the third node N3, which is connected to the gate electrode of the first transistor T1. The third transistor T3 may be a double-gate transistor having two gate electrodes (e.g., a gate electrode and an opposing gate electrode). The gate electrode and the opposing gate electrode may face each other in different layers.

The fourth transistor T4 may be turned on by an initialization gate signal SGB from the initialization gate line SGL to electrically connect the second node N2 and the initialization voltage line VIL. The fourth transistor T4 may be electrically connected between the second node N2 and the initialization voltage line VIL. For example, a gate electrode of the fourth transistor T4 may be electrically connected to the initialization gate line SGL, a drain electrode of the fourth transistor T4 may be electrically connected to the second node N2, and a source electrode of the fourth transistor T4 may be electrically connected to the initialization voltage line VIL. The fourth transistor T4 may also be a double-gate transistor. The initialization voltage line VIL may transmit an initialization voltage VINT.

The fifth transistor T5 may be turned on by the light emitting signal EM from the light emitting line EML to electrically connect the driving voltage line VDL and the first node N1, which is connected to the source electrode of the first transistor T1. A gate of the fifth transistor T5 may be electrically connected to the light emitting line EML, a source electrode of the fifth transistor T5 may be electrically connected to the driving voltage line VDL, and a drain electrode of the fifth transistor T5 may be electrically connected to the first node N1.

The sixth transistor T6 may be turned on by the light emitting signal EM from the light emitting line EML to electrically connect the second node N2, which is connected to the drain electrode of the first transistor T1, and the anode electrode of the light emitting element ED. A gate of the sixth transistor T6 may be electrically connected to the light emitting line EML, a drain electrode of the sixth transistor T6 may be electrically connected to the second node N2, and a source electrode of the sixth transistor T6 may be electrically connected to the anode electrode of the light emitting element ED. In case that the fifth transistor T5, the first transistor T1, and the sixth transistor T6 are all turned on, the driving current Isd may be supplied to the light emitting element ED.

The seventh transistor T7 may be turned on by a bias gate signal GB from the bias gate line GBL to electrically connect the bias voltage line VBL and the first node N1, which is connected to the source electrode of the first transistor T1. The seventh transistor T7 may be turned on by the bias gate signal GB, thereby supplying the bias voltage VB to the first node N1. The seventh transistor T7 may improve hysteresis of the first transistor T1 by supplying the bias voltage VB to the source electrode of the first transistor T1. A gate electrode of the seventh transistor T7 may be electrically connected to the bias gate line GBL, a source electrode of the seventh transistor T7 may be electrically connected to the bias voltage line VBL, and a drain electrode of the seventh transistor T7 may be electrically connected to the first node N1.

The eighth transistor T8 may be turned on by the bias gate signal GB from the bias gate line GBL to electrically connect the anode electrode of the light emitting element ED and the light emitting initialization line VAIL. A gate electrode of the eighth transistor T8 may be electrically connected to the bias gate line GBL, a source electrode of the eighth transistor T8 may be electrically connected to the light emitting initialization line VAIL, and a drain electrode of the eighth transistor T8 may be electrically connected to the anode electrode of the light emitting element ED. The eighth transistor T8 may be turned on by the bias gate signal GB, thereby allowing current from the anode electrode of the light emitting element ED to flow to the light emitting initialization line VAIL. The eighth transistor T8 may be a double-gate transistor. The light emitting initialization line VAIL may supply a light emitting initialization voltage VAINT.

Each of the first transistor T1, the second transistor T2, and the fourth to eighth transistors T4 to T8 may include a silicon-based active layer. For example, each of the first transistor T1, the second transistor T2, and the fourth to eighth transistors T4 to T8 may be a p-type transistor including an active layer made of low temperature polycrystalline silicon (LTPS). The active layer made of low temperature polycrystalline silicon may have high electron mobility and excellent turn-on characteristics. Therefore, the display device 10 may stably and efficiently drive the pixels PX by including transistors with excellent turn-on characteristics. Each of the first transistor T1, the second transistor T2, and the fourth to eighth transistors T4 to T8 may output the current flowing into the source electrode to the drain electrode based on a gate low voltage applied to the gate electrode thereof.

The third transistor T3 may be an n-type transistor including an oxide-based active layer. The transistor including an oxide-based active layer may have a coplanar structure in which a gate electrode is disposed thereon. The transistor including an oxide-based active layer may output the current flowing into the drain electrode to the source electrode based on a gate high voltage applied to the gate electrode thereof.

The capacitor Cst may be connected between the third node N3, which is connected to the gate electrode of the first transistor T1, and the driving voltage line VDL. For example, a first electrode of the capacitor Cst may be electrically connected to the third node N3, and a second electrode of the capacitor Cst may be electrically connected to the driving voltage line VDL, thereby maintaining a potential difference between the driving voltage line VDL and the gate electrode of the first transistor T1.

The bias voltage VB may be greater than a driving voltage ELVDD, the driving voltage ELVDD may be greater than a common voltage ELVSS, and the common voltage ELVSS may be greater than the initialization voltage VINT and the light emitting initialization voltage VAINT. However, the disclosure is not limited thereto, and in another embodiment, the common voltage ELVSS may be equal to or smaller than the initialization voltage VINT. The light emitting initialization voltage VAINT may be lower than or equal to the initialization voltage VINT. The bias voltage VB may be a voltage close to black gradation (e.g., 5 V). Each pixel PX of the FIGS. 3 and 4 described above may be formed with the circuit configuration illustrated in FIG. 5.

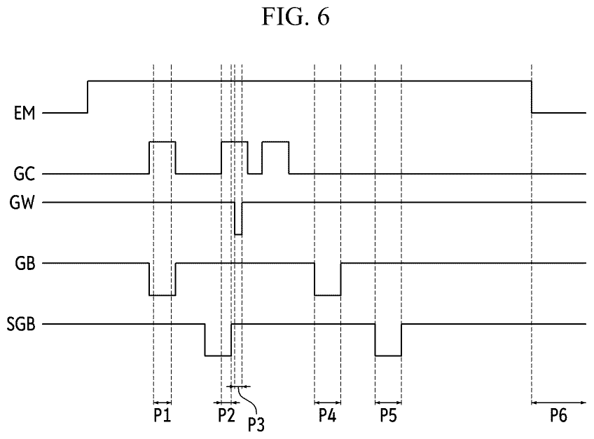

FIG. 6 is a schematic timing diagram of a light emitting signal, a compensation gate signal, a write gate signal, a bias gate signal, and a modulated initialization gate signal of FIG. 5.

For example, FIG. 6 is a schematic timing diagram of a light emitting signal EM, a compensation gate signal GC, a write gate signal GW, a bias gate signal GB, and an initialization gate signal SGB of FIG. 5.

The gate driver 610 may generate gate scan signals including a compensation gate signal GC, a bias gate signal GB, and a modulated initialization gate signal SGB based on the gate control signal GCS input from the timing controller 210.

The gate driver 610 may include a first shift register that sequentially generates a compensation gate signal GC in response to the gate control signal GCS and outputs the compensation gate signal GCS to each compensation gate line GCL. The gate driver 610 may include a second shift register that sequentially generates a bias gate signal GB in response to the gate control signal GCS and outputs the bias gate signal GB to each bias gate line GBL. The gate driver 610 may further include delay circuits that sequentially delay the bias gate signal GB output from the second shift register and output the delayed bias gate signal as the initialization gate signal SGB to the initialization gate lines SGL.

The gate driver 610 may not separately generate the initialization gate signals SGB based on the gate control signal GCS, but sequentially delays the bias gate signals GB output from the second shift register and outputs the delayed bias gate signals as the initialization gate signals SGB. Accordingly, by forming and using a delay circuit formed with a simple circuit structure instead of a shift register formed with a complex structure, an internal circuit structure of the gate driver 610 may be simplified, and the size and formation area may be reduced. To this end, the fourth transistor T4 that operates in response to the initialization gate signal SGB may be formed as a p-type transistor in the same manner as the seventh transistor T7 that operates in response to the bias gate signal GB. For example, each of the fourth transistor T4 and the seventh and eighth transistors T7 and T8 may be formed as a p-type transistor including an active layer of a low-temperature polycrystalline silicon type.

On the other hand, the emission control driver 620 may generate light emitting scan signals including a write gate signal GW and a light emitting signal EM based on the emission control signal ECS input from the timing controller 210.

Referring to FIG. 6, the pixels PX of the display device 10 may operate in accordance with operation periods including a first period P1, a second period P2, a third period P3, a fourth period P4, a fifth period P5, and a sixth period P6.

The light emitting signal EM, the compensation gate signal GC, the write gate signal GW, the bias gate signal GB, and the modulated initialization gate signal SGB may each be varied to an active level or a non-active level for each of the periods P1, P2, P3, P4, P5, and P6 described above. The active level of each of the signals EM, GC, GW, GB, and SGB described above may be a voltage level that may turn on the corresponding transistor to which the corresponding signal is applied. In other words, the signal of the active level may have a value greater than a threshold voltage of the corresponding transistor. For example, in case that the corresponding transistor is an n-type transistor, the active level of the signal applied to the gate electrode of the corresponding transistor may be a high level (e.g., a positive polarity level or a high voltage level).

The non-active level of each of the signals EM, GC, GW, GB, and SGB may be a voltage level that may turn off the corresponding transistor. In other words, the signal of the non-active level may have a value smaller than the threshold voltage of the corresponding transistor. For example, in case that the corresponding transistor is an n-type transistor, the non-active level of the signal applied to the gate electrode of the corresponding transistor may be a low level (e.g., a negative polarity level or a low voltage level).

Unlike this, in case that the corresponding transistor is a p-type transistor, the active level of the signal applied to the gate electrode of the corresponding transistor may be a low level (e.g., a negative polarity level or a low voltage level), and the non-active level of the signal applied to the gate electrode of the corresponding transistor may be a high level (e.g., a positive polarity level or a high voltage level).

In the first period P1, the compensation gate signal GC and the bias gate signal GB may each have an active level. In the first period P1, the light emitting signal EM, the initialization gate signal SGB, and the write gate signal GW may each have a non-active level. The first period P1 may be, for example, a period for improving the hysteresis of the first transistor T1.

In the second period P2, the initialization gate signal SGB and the compensation gate signal GC may each have an active level. In the second period P2, the light emitting signal EM, the write gate signal GW, and the bias gate signal GB may each have a non-active level. The second period P2 may be, for example, a period for initializing a voltage of the gate electrode of the first transistor T1.

In the third period P3, the compensation gate signal GC and the write gate signal GW may each have an active level. In the third period P3, the light emitting signal EM, the initialization gate signal SGB, and the bias gate signal GB may each have a non-active level. In the third period P3, the data voltage may be provided to the data line DL. The third period P3 may be, for example, a period for supplying the data voltage to the pixel circuit PC and detecting and compensating for the threshold voltage of the first transistor T1.

In the fourth period P4, the bias gate signal GB may have an active level. In the fourth period P4, the light emitting signal EM, the initialization gate signal SGB, the compensation gate signal GC, and the write gate signal GW may each have a non-active level. The fourth period P4 may be, for example, a period for improving the expression of black gradation by discharging the voltages of the drain electrode of the first transistor T1 and the anode electrode of the light emitting element ED.

In the fifth period P5, the initialization gate signal SGB may have an active level. In the fifth period P5, the light emitting signal EM, the compensation gate signal GC, the write gate signal GW, and the bias gate signal GB may each have a non-active level. The fifth period P5 may be, for example, a period for further improving the hysteresis of the first transistor T1.

In the sixth period P6, the light emitting signal EM may have an active level. In the sixth period P6, the initialization gate signal SGB, the compensation gate signal GC, the write gate signal GW, and the bias gate signal GB may each have a non-active level. The sixth period P6 may be, for example, a period for emitting light from the light emitting element ED.

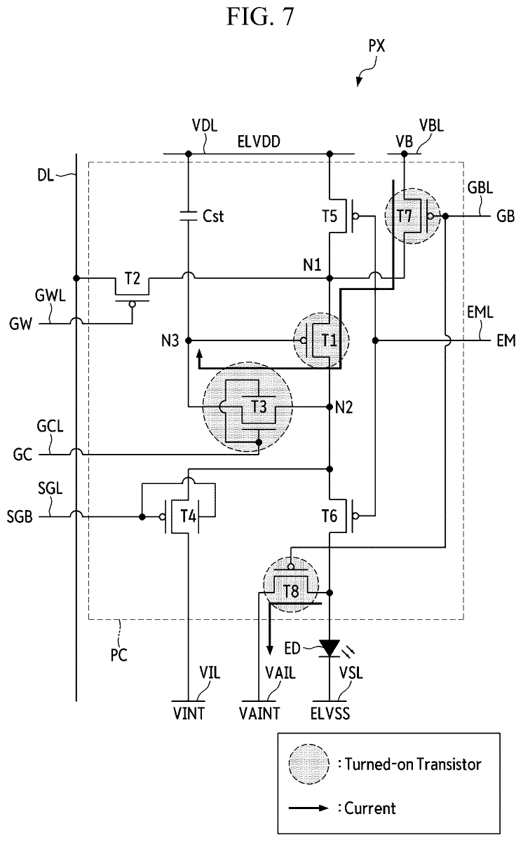

An operation of the display device 10 according to an embodiment will be described as follows with reference to FIGS. 7 to 12. The transistors surrounded by a dotted circle in FIGS. 7 to 12 may be turned-on transistors, and transistors except the transistors surrounded by the dotted circle may be turn-off transistors.

FIG. 7 is a schematic diagram for describing an operation of the pixel of FIG. 5 in a first period of FIG. 6.

First, the operation of the pixel in the first period P1 will be described as follows with reference to FIGS. 6 and 7.

As illustrated in FIG. 6, in the first period P1, the compensation gate signal GC and the bias gate signal GB may each have an active level. In the first period P1, the initialization gate signal SGB generated by delaying the light emitting signal EM, the write gate signal GW, and the bias gate signal GB may each be at a non-active level.

The compensation gate signal GC of the active level may be applied to the gate electrode of the third transistor T3 through the compensation gate line GCL. Accordingly, the third transistor T3 may be turned on.

The bias gate signal GB of the active level may be applied to the gate electrode of the seventh transistor T7 and the gate electrode of the eighth transistor T8, respectively, through the bias gate line GBL. Accordingly, the seventh transistor T7 and the eighth transistor T8 may be turned on.

The write gate signal GW of the non-active level may be applied to the gate electrode of the second transistor T2 through the write gate line GWL. Accordingly, the second transistor T2 may be turned off.

The initialization gate signal SGB of the non-active level may be applied to the gate electrode of the fourth transistor T4 through the initialization gate line SGL. Accordingly, the fourth transistor T4 may be turned off.

The light emitting signal EM of the non-active level may be applied to the gate electrode of the fifth transistor T5 and the gate electrode of the sixth transistor T6, respectively, through the light emitting line EML. Accordingly, the fifth transistor T5 and the sixth transistor T6 may be turned off.

As described above, as the seventh transistor T7 is turned on, the bias voltage VB from the bias voltage line VBL may be applied to the source electrode (e.g., the first node N1) of the first transistor T1 through the turned-on seventh transistor T7. A voltage difference between the gate electrode of the first transistor T1 and the source electrode of the first transistor T1 (hereinafter, a gate-source voltage) may become greater than the threshold voltage of the first transistor T1, and the first transistor T1 may be turned on.

As the third transistor T3 is turned on by the compensation gate signal GC of the active level, the gate electrode (e.g., the third node N3) and the drain electrode (e.g., the second node N2) of the first transistor T1 may be electrically connected to each other. In other words, the first transistor T1 may be connected to the pixel circuit PC in the form of a diode. Accordingly, a current may be generated that flows in a direction from the bias voltage line VBL toward the drain electrode (e.g., the second node N2) and the source electrode (e.g., the third node N3) of the first transistor T1 through the turned-on first transistor T1. Accordingly, in case that the voltage of the gate electrode (e.g., the first node N1) of the first transistor T1 increases, and the gate-source voltage of the first transistor T1 becomes equal to the threshold voltage of the first transistor T1, the first transistor T1 may be turned off.

As described above, as the first transistor T1, the third transistor T3, and the seventh transistor T7 are each turned on, the bias voltage VB from the bias voltage line VBL may be applied to the first node N1, the second node N2, and the third node N3, respectively, through the first transistor T1, the third transistor T3, and the seventh transistor T7 that are turned on. Therefore, in the first period P1, the hysteresis of the first transistor T1 may be improved. In the first period P1, the voltage of the source electrode of the first transistor T1 may be initialized to the bias voltage VB.

As the eighth transistor T8 is turned on by the bias gate signal GB of the active level, the voltage of the anode electrode of the light emitting element ED may be initialized to a voltage of the light emitting initialization voltage VAINT of the light emitting initialization line VAIL.

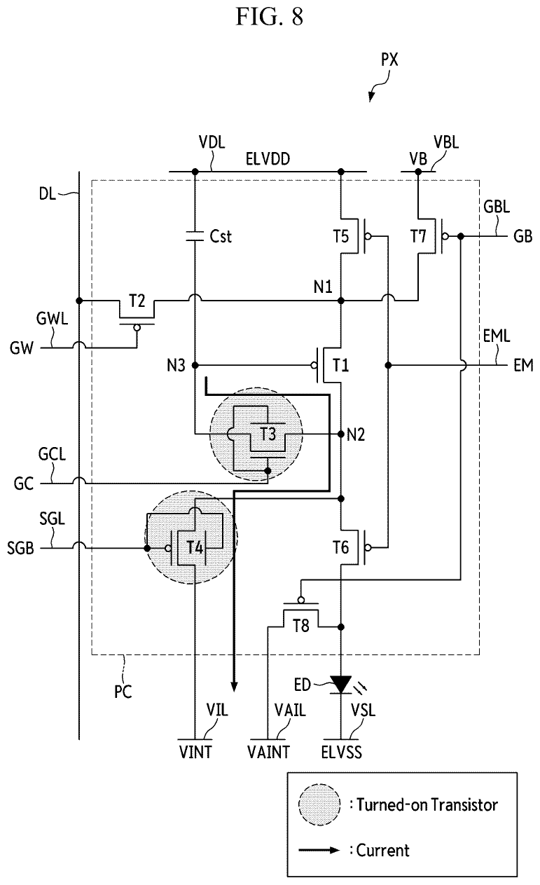

FIG. 8 is a schematic diagram for describing an operation of the pixel of FIG. 5 in a second period of FIG. 6.

As illustrated in FIG. 6, in the second period P2, the initialization gate signal SGB and the compensation gate signal GC may each be supplied at an active level. In the second period P2, the light emitting signal EM, the write gate signal GW, and the bias gate signal GB may each be maintained at a non-active level.

The compensation gate signal GC of the active level may be applied to the gate electrode of the third transistor T3 through the compensation gate line GCL. Accordingly, the third transistor T3 may be turned on.

The initialization gate signal SGB of the active level may be applied to the gate electrode of the fourth transistor T4 through the initialization gate line SGL. Accordingly, the fourth transistor T4 may be turned on.

The light emitting signal EM of the non-active level may be applied to the gate electrode of the fifth transistor T5 and the gate electrode of the sixth transistor T6, respectively, through the light emitting line EML. Accordingly, the fifth transistor T5 and the sixth transistor T6 may be turned off.

The bias gate signal GB of the non-active level may be applied to the gate electrode of the seventh transistor T7 and the gate electrode of the eighth transistor T8, respectively, through the bias gate line GBL. Accordingly, the seventh transistor T7 and the eighth transistor T8 may be turned off.

As described above, as the third transistor T3 is turned on, the gate electrode (e.g., the third node N3) and the drain electrode (e.g., the second node N2) of the first transistor T1 may be electrically connected to each other. The first transistor T1 may be maintained in a turned-off state as in the previous period (e.g., the second period P2).

As described above, as the third transistor T3 and the fourth transistor T4 are each turned on, the initialization voltage VINT from the initialization voltage line VIL may be applied to the second node N2 and the third node N3, respectively, through the third transistor T3 and the fourth transistor T4 that are turned on. Therefore, in the second period P2, the voltage of the gate electrode of the first transistor T1 and the voltage of the drain electrode of the first transistor T1 may each be initialized to the initialization voltage VINT.

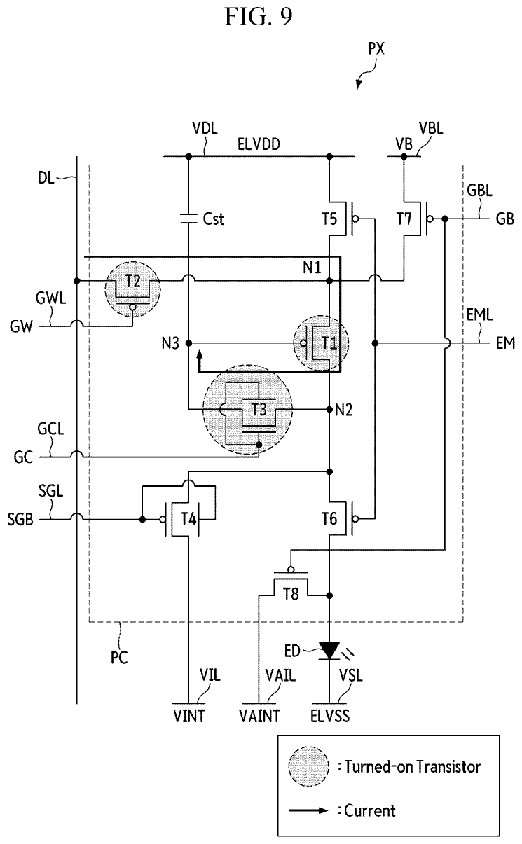

The operation of the pixel in the third period P3 will be described as follows with reference to FIGS. 6 and 9.

FIG. 9 is a schematic diagram for describing an operation of the pixel of FIG. 5 in a third period of FIG. 6.

As illustrated in FIG. 6, in the third period P3, the compensation gate signal GC and the write gate signal GW may each have an active level. In the third period P3, the light emitting signal EM, the initialization gate signal SGB, and the bias gate signal GB may each have a non-active level. In the third period P3, the data voltage may be provided to the data line DL.

The write gate signal GW of the active level may be applied to the gate electrode of the second transistor T2 through the write gate line GWL. Accordingly, the second transistor T2 may be turned on.

The compensation gate signal GC of the active level may be applied to the gate electrode of the third transistor T3 through the compensation gate line GCL. Accordingly, the third transistor T3 may be turned on.

The initialization gate signal SGB of the non-active level may be applied to the gate electrode of the fourth transistor T4 through the initialization gate line SGL. Accordingly, the fourth transistor T4 may be turned off.

The light emitting signal EM of the non-active level may be applied to the gate electrode of the fifth transistor T5 and the gate electrode of the sixth transistor T6 through the light emitting line EML. Accordingly, the fifth transistor T5 and the sixth transistor T6 may be turned off.

The bias gate signal GB of the non-active level may be applied to the gate electrode of the seventh transistor T7 through the bias gate line GBL. Accordingly, the seventh transistor T7 may be turned off.

As described above, as the third transistor T3 is turned on, the gate electrode (e.g., the third node N3) and the drain electrode (e.g., the second node N2) of the first transistor T1 may be electrically connected to each other. In other words, the first transistor T1 may be connected to the pixel circuit in the form of a diode.

As described above, as the second transistor T2 is turned on, the data voltage from the data line DL may be applied to the source electrode (e.g., the first node N1) of the first transistor T1 through the turned-on second transistor T2. The voltage of the source electrode of the first transistor T1 may be maintained at the data voltage as described above, while the voltage of the gate electrode (e.g., the third node N3) of the first transistor T1 may gradually increase. In other words, as the current generated by the data voltage applied to the first node N1 is supplied to the second node N2 and the third node N3 through the turned-on first transistor T1, the voltage of the gate electrode of the first transistor T1 may gradually increase. As the voltage of the gate electrode of the first transistor T1 gradually increases, the gate-source voltage of the first transistor T1 may gradually decrease. In this way, at a point of time when the gate-source voltage of the first transistor T1 decreases and reaches the threshold voltage of the first transistor T1, the first transistor T1 may be turned off. Therefore, at the point of time when the first transistor T1 is turned off, the threshold voltage of the first transistor T1 may be detected and the detected threshold voltage may be reflected to the third node N3. For example, at the point of time when the first transistor T1 is turned off, the voltage of the third node N3 may be a voltage obtained by subtracting the threshold voltage of the first transistor T1 from the data voltage. The voltage of the third node N3 (e.g., data voltage-threshold voltage of the first transistor T1) may be stored by the capacitor Cst and maintained for a certain period of time. Therefore, in the third period P3, the data voltage may be applied and the threshold voltage of the first transistor T1 may be detected and maintained. Therefore, in the third period P3, the voltage of the third node N3 may include the threshold voltage of the first transistor T1.

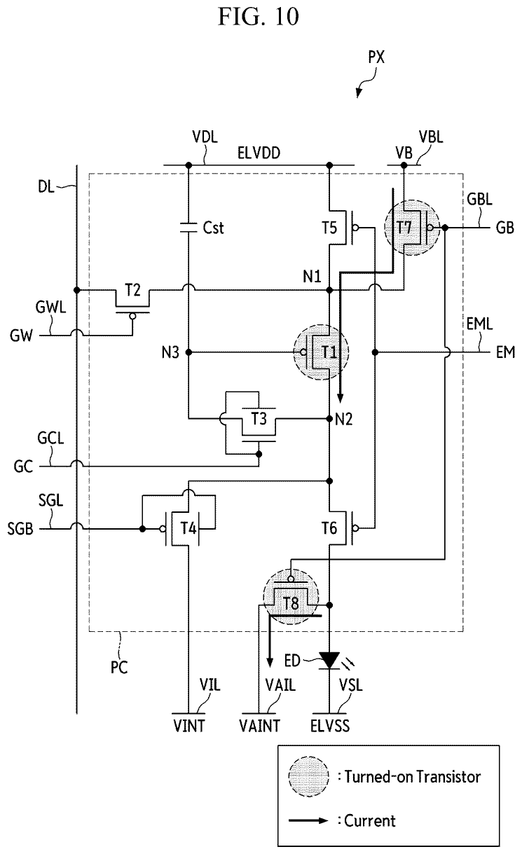

The operation of the pixel in the fourth period P4 will be described as follows with reference to FIGS. 6 and 10.

FIG. 10 is a schematic diagram for describing an operation of the pixel of FIG. 5 in a fourth period of FIG. 6.

As illustrated in FIG. 6, in the fourth period P4, the bias gate signal GB may have an active level. In the fourth period P4, the light emitting signal EM, the initialization gate signal SGB, the compensation gate signal GC, and the write gate signal GW may each have a non-active level.

The bias gate signal GB of the active level may be applied to the gate electrode of the seventh transistor T7 and the gate electrode of the eighth transistor T8, respectively, through the bias gate line GBL. Accordingly, the seventh transistor T7 and the eighth transistor T8 may be turned on.

The write gate signal GW of the non-active level may be applied to the gate electrode of the second transistor T2 through the write gate line GWL. Accordingly, the second transistor T2 may be turned off.

The compensation gate signal GC of the non-active level may be applied to the gate electrode of the third transistor T3 through the compensation gate line GCL. Accordingly, the third transistor T3 may be turned off.

The initialization gate signal SGB of the non-active level may be applied to the gate electrode of the fourth transistor T4 through the initialization gate line SGL. Accordingly, the fourth transistor T4 may be turned off.

The light emitting signal EM of the non-active level may be applied to the gate electrode of the fifth transistor T5 and the gate electrode of the sixth transistor T6, respectively, through the light emitting line EML. Accordingly, the fifth transistor T5 and the sixth transistor T6 may be turned off.

As described above, as the seventh transistor T7 is turned on, the bias voltage from the bias voltage line VBL may be applied to the source electrode (e.g., the first node N1) of the first transistor T1 through the turned-on seventh transistor T7. Accordingly, the voltage of the source electrode of the first transistor T1 may gradually increase, and accordingly, the gate-source voltage of the first transistor T1 may become greater than the threshold voltage of the first transistor T1, and thus the first transistor T1 may be turned on. The bias voltage VB from the bias voltage line VBL may be applied to the first node N1 and the second node N2 through the turned-on first transistor T1. The voltage of the second node N2 may be a differential voltage obtained by subtracting the threshold voltage of the first transistor T1 from the bias voltage VB. Accordingly, in the fourth period P4, the hysteresis of the first transistor T1 may be improved. Therefore, even in case that a scanning rate of the display device 10 rapidly changes, a deviation of the driving current Isd flowing through the first transistor T1 may be minimized, so that an image quality of the display device 10 may be improved.

As the eighth transistor T8 is turned on by the bias gate signal GB of the active level, the voltage of the anode electrode of the light emitting element ED may be initialized to a voltage of the light emitting initialization voltage VAINT of the light emitting initialization line VAIL. As the voltage of the anode electrode of the light emitting element ED is maintained to be low at the light emitting initialization voltage VAINT in the fourth period P4, the light emitting element ED may be turned off at a sufficiently fast speed even in case that a gradation of the data voltage rapidly changes from white gradation to black gradation. Therefore, even in case that an image rapidly changes from the white gradation to the black gradation, the image corresponding to the black gradation may be accurately expressed. Therefore, the fourth period P4 may be a period for improving the expression of black gradation by discharging the voltages across the drain electrode of the first transistor T1 and the anode electrode of the light emitting element ED.

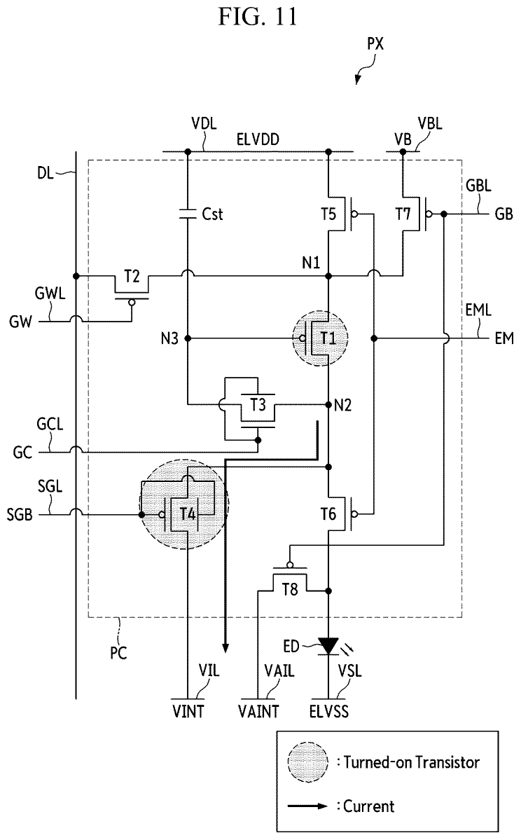

The operation of the pixel in the fifth period P5 will be described as follows with reference to FIGS. 6 and 11.

FIG. 11 is a schematic diagram for describing an operation of the pixel of FIG. 5 in a fifth period of FIG. 6.

As illustrated in FIG. 6, in the fifth period P5, the initialization gate signal SGB may be supplied at an active level. In the fifth period P5, the light emitting signal EM, the compensation gate signal GC, the write gate signal GW, and the bias gate signal GB may each be supplied at a non-active level.

The initialization gate signal SGB of the active level may be applied to the gate electrode of the fourth transistor T4 through the initialization gate line SGL. Accordingly, the fourth transistor T4 may be turned on.

The write gate signal GW of the non-active level may be applied to the gate electrode of the second transistor T2 through the write gate line GWL. Accordingly, the second transistor T2 may be turned off.

The compensation gate signal GC of the non-active level may be applied to the gate electrode of the third transistor T3 through the compensation gate line GCL. Accordingly, the third transistor T3 may be turned off.

The light emitting signal EM of the non-active level may be applied to the gate electrode of the fifth transistor T5 and the gate electrode of the sixth transistor T6, respectively. Accordingly, the fifth transistor T5 and the sixth transistor T6 may be turned off.

The bias gate signal GB of the non-active level may be applied to the gate electrode of the seventh transistor T7 and the gate electrode of the eighth transistor T8, respectively, through the bias gate line GBL. Accordingly, the seventh transistor T7 and the eighth transistor T8 may be turned off.

As described above, as the fourth transistor T4 is turned on, the initialization voltage VINT from the initialization voltage line VIL may be applied to the drain electrode (e.g., the second node N2) of the first transistor T1 through the turned-on fourth transistor T4. Accordingly, the voltage of the drain electrode of the first transistor T1 may be discharged to the initialization voltage VINT. Accordingly, the voltage of the second node N2 may be maintained at a low voltage in the fifth period P5. As the voltage of the second node electrode is maintained to be low at the initialization voltage VINT in the fifth period P5, the light emitting element ED may be turned off at a sufficiently fast speed in the next period (e.g., the sixth period P6) even in case that a gradation of the data voltage rapidly changes from white gradation to black gradation. Therefore, even in case that an image rapidly changes from the white gradation to the black gradation, the image corresponding to the black gradation may be accurately expressed.

In other words, the second node N2 may be maintained at a high voltage (e.g., bias voltage-threshold voltage of the first transistor T1) in the preceding period (e.g., the third period P3) to improve the hysteresis of the first transistor T1 described above, and in such cases, it may be difficult to normally express the black gradation when changing from white gradation to black gradation. In order to solve the above-mentioned problem, the voltage of the second node N2 may be pre-discharged to a low voltage (e.g., the initialization voltage VINT) in the fifth period P5 prior to the light emitting period (e.g., the sixth period P6).

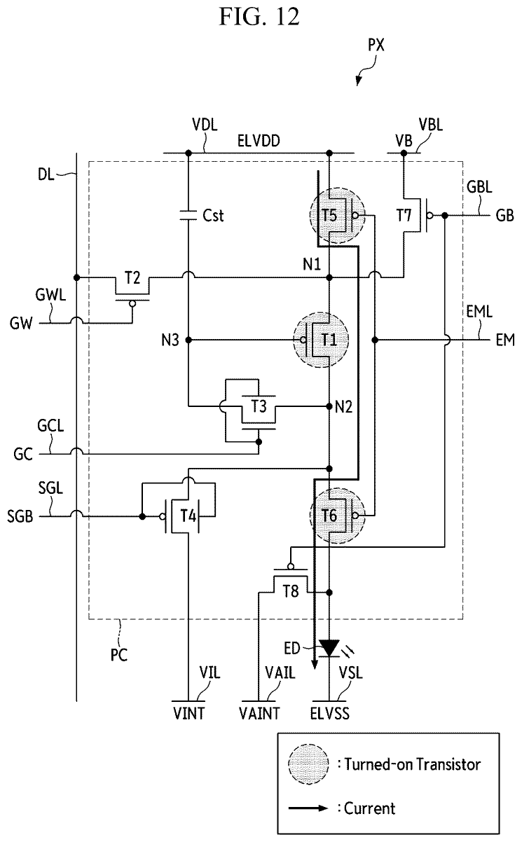

The operation of the pixel in the sixth period P6 will be described as follows with reference to FIGS. 6 and 12.

FIG. 12 is a schematic diagram for describing an operation of the pixel of FIG. 5 in a sixth period of FIG. 6.

As illustrated in FIG. 6, in the sixth period P6, the light emitting signal EM may be supplied at an active level through the light emitting line EML. In the sixth period P6, the initialization gate signal SGB, the compensation gate signal GC, the write gate signal GW, and the bias gate signal GB may each be supplied at a non-active level.

The light emitting signal EM of the active level may be applied to the gate electrode of the fifth transistor T5 and the gate electrode of the sixth transistor T6, respectively, through the light emitting line EML. Accordingly, the fifth transistor T5 and the sixth transistor T6 may be turned on.

The write gate signal GW of the non-active level may be applied to the gate electrode of the second transistor T2 through the write gate line GWL. Accordingly, the second transistor T2 may be turned off.

The compensation gate signal GC of the non-active level may be applied to the gate electrode of the third transistor T3 through the compensation gate line GCL. Accordingly, the third transistor T3 may be turned off.

The initialization gate signal SGB of the non-active level may be applied to the gate electrode of the fourth transistor T4 through the initialization gate line SGL. Accordingly, the fourth transistor T4 may be turned off.

The bias gate signal GB of the non-active level may be applied to the gate electrode of the seventh transistor T7 through the bias gate line GBL. Accordingly, the seventh transistor T7 may be turned off.

The first transistor T1 may be maintained in a turned-on state by the gate-source voltage maintained by the capacitor.

In the sixth period P6, as the first transistor T1, the fifth transistor T5, and the sixth transistor T6 are each turned on, the driving current Isd may be supplied to the light emitting element ED through the first transistor T1, the fifth transistor T5, and the sixth transistor T6 that are turned on. Therefore, the light emitting element ED may emit light depending on the driving current Isd. The gate-source voltage maintained by the capacitor Cst may include the threshold voltage of the first transistor T1, and the magnitude of the driving current Isd flowing to the light emitting element ED through the turned-on first transistor T1 may be determined based on the data voltage and the threshold voltage of the first transistor T1. Therefore, the driving current Isd supplied to the light emitting element ED may accurately reflect the magnitude of the data voltage. In this way, since the threshold voltages of the first transistors T1 of each pixel PX are compensated to determine the driving current Isd of each pixel PX, a luminance deviation between the pixels PX due to the deviation in threshold voltage between the first transistors T1 of each pixel PX may be minimized. Therefore, an image quality of the display device 10 may be improved.

According to an embodiment, since the voltage of the second node N2 is discharged to the initialization voltage VINT in the preceding period (e.g., the fifth period P5) and is maintained at a low voltage, a voltage difference between the anode electrode of the light emitting element ED (e.g., the anode electrode connected to the source electrode of the sixth transistor T6) and the cathode electrode of the light emitting element ED in the sixth period P6 may be maintained to be small. In other words, the voltage of the anode electrode of the light emitting element ED may be maintained to be sufficiently low in the sixth period P6. Therefore, as described above, since the voltage of the anode electrode of the light emitting element ED may be lowered at a fast speed, even in case that the gradation of the data voltage rapidly changes from white gradation to black gradation in adjacent frame periods, an image of black gradation may be accurately expressed.

Since the first transistor T1 is already turned on so that a large amount of current may flow due to the data voltage of the white gradation when changing from the black gradation to the white gradation, the voltage of the anode electrode of the light emitting element ED may be increased from the black gradation to a large voltage corresponding to the white gradation in a sufficiently fast time even in case that the voltage of the second node N2 is discharged to the low voltage such as the initialization voltage VINT. Therefore, the image quality of the display device 10 may be improved. Since the black gradation may be improved in this way, a swing range of the data voltage may be reduced, and thus power consumption of the display device 10 may be improved.

According to an embodiment, since the fourth transistor T4 is disposed between the drain electrode of the first transistor T1 and the initialization voltage line VIL, the voltage difference between the voltage of the drain electrode of the first transistor T1 and the initialization voltage VINT may be low, and thus a leakage current (e.g., an off leakage current) of the fourth transistor T4 may be minimized. Accordingly, an image may be displayed without flicker even in case that the display device 10 is driven at a low frequency.

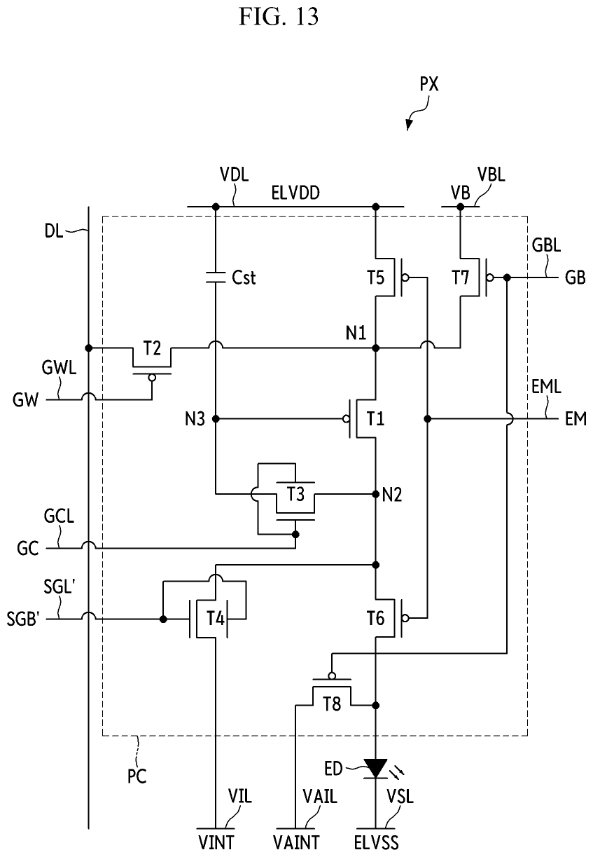

FIG. 13 is a schematic diagram of an equivalent circuit of one pixel of a display device according to a second embodiment.

Referring to FIG. 13, the pixel PX may include a pixel circuit PC and a light emitting element ED, and the pixel circuit PC may include a first transistor T1, a second transistor T2, a third transistor T3, a fourth transistor T4, a fifth transistor T5, a sixth transistor T6, a seventh transistor T7, an eighth transistor T8, and a capacitor Cst.

A connection structure of the first to third transistors T1 to T3 and the fifth to eighth transistors T5 to T8 of the pixel circuit PC illustrated in FIG. 13 may be same as the connection structure of the first to third transistors T1 to T3 and the fifth to eighth transistors T5 to T8 illustrated in FIG. 5. Therefore, the description of the arrangement and connection structural features of the first to third transistors T1 to T3 and the fifth to eighth transistors T5 to T8 will be replaced with the description of FIG. 5.

However, the fourth transistor T4 illustrated in FIG. 13 may be an n-type transistor including an oxide-based active layer, similarly to the third transistor T3. The fourth transistor T4 including an oxide-based active layer may output the current flowing into the drain electrode to the source electrode based on a gate high voltage applied to the gate electrode thereof.

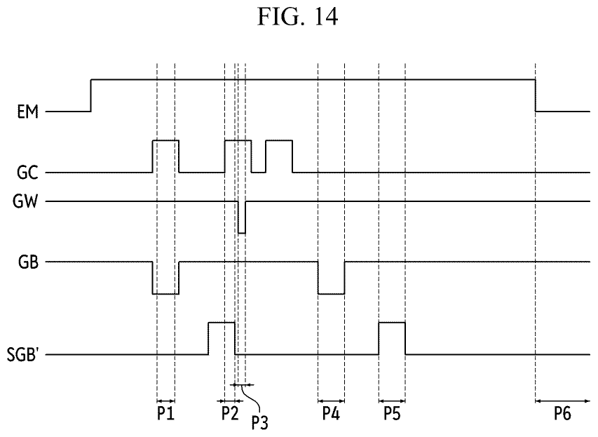

FIG. 14 is a schematic timing diagram of a light emitting signal, a compensation gate signal, a write gate signal, a bias gate signal, and a modulated initialization gate signal of FIG. 13.

Referring to FIGS. 13 and 14, the fourth transistor T4 may be formed as an n-type transistor and output the current flowing into the drain electrode to the source electrode based on the gate high voltage. Accordingly, the gate driver 610 may generate an initialization gate signal SGB′ of which phase is inverted so that the gate high voltage is generated as an active voltage and supply the initialization gate signal SGB′ to the initialization gate lines SGL. To this end, the gate driver 610 may generate the initialization gate signal SGB′ of which phase is inverted using at least one delay circuit and at least one inversion gate circuit.

For example, the gate driver 610 may sequentially generate the bias gate signal GB according to the gate control signal GCS using the second shift register, and sequentially output the bias gate signal GB to each bias gate line GBL. Accordingly, the gate driver 610 may sequentially delay the bias gate signals GB using at least one delay circuit connected in parallel to each bias gate line GBL. The gate driver 610 may invert the phases of the bias gate signals GB that are sequentially delayed using at least one inversion gate circuit connected in series to each delay circuit, and output the bias gate signals GB as initialization gate signals SGB′ of which phases are inverted to the initialization gate lines SGL.

Referring to FIG. 14, the pixels PX of the display device 10 may operate in accordance with operation periods including a first period P1, a second period P2, a third period P3, a fourth period P4, a fifth period P5, and a sixth period P6. However, the operation order of pixels PX for each period will be replaced with the description of FIGS. 6 to 12.

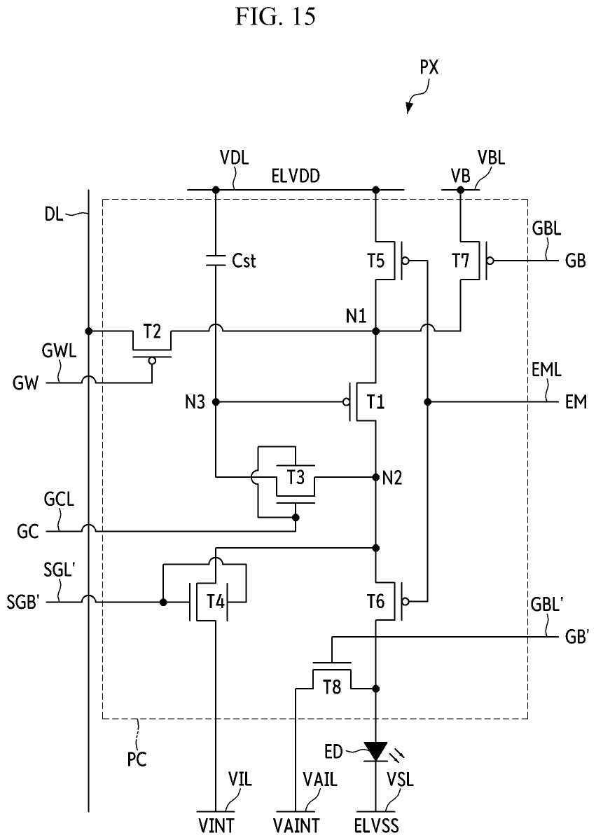

FIG. 15 is a schematic diagram of an equivalent circuit of one pixel of a display device according to a third embodiment.

Referring to FIG. 15, the pixel PX may include a pixel circuit PC and a light emitting element ED, and the pixel circuit PC may include first to eighth transistors T1 to T8 and a capacitor Cst.

A connection structure of the first to third transistors T1 to T3 and the fifth to seventh transistors T5 to T7 of the pixel circuit PC illustrated in FIG. 15 may be same as the connection structure of the first to third transistors T1 to T3 and the fifth to seventh transistors T5 to T7 illustrated in FIG. 5. Therefore, the description of the arrangement and connection structural features of the first to third transistors T1 to T3 and the fifth to seventh transistors T5 to T7 will be replaced with the description of FIG. 5.

However, the fourth transistor T4 and the eighth transistor T8 illustrated in FIG. 15 may be n-type transistors including an oxide-based active layer, similarly to the third transistor T3. The fourth transistor T4 and the eighth transistor T8 including an oxide-based active layer may output the current flowing into the drain electrode to the source electrode based on a gate high voltage applied to the gate electrode.

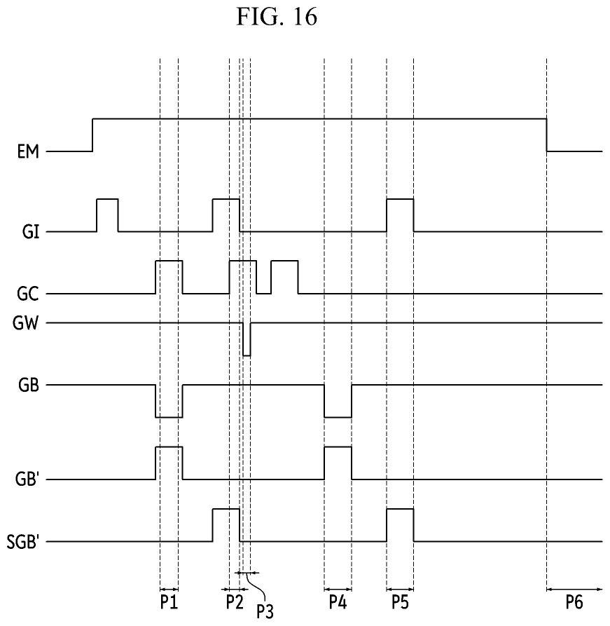

FIG. 16 is a schematic timing diagram of a light emitting signal, a compensation gate signal, a write gate signal, a bias gate signal, a modulated bias control signal, and a modulated initialization gate signal of FIG. 15.

Referring to FIGS. 15 and 16, the fourth transistor T4 and the eighth transistor T8 may be formed as n-type transistors and output the current flowing into the drain electrode to the source electrode based on the gate high voltage. Accordingly, the gate driver 610 may generate an initialization gate signal SGB′ of which phase is inverted so that the gate high voltage is generated as an active voltage and supply the initialization gate signal SGB′ to the initialization gate lines SGL. The gate driver 610 may generate a bias gate signal GB′ of which phase is inverted so that the gate high voltage is generated as an active voltage and supply the bias gate signal GB′ to an inverted bias gate line GBL′ of the eighth transistor T8. To this end, the gate driver 610 may generate the initialization gate signal SGB′ of which phase is inverted using at least one delay circuit and at least one inversion gate circuit.

For example, the gate driver 610 may sequentially generate the bias gate signal GB according to the gate control signal GCS using the second shift register, and sequentially output the bias gate signal GB to each bias gate line GBL. Accordingly, the gate driver 610 may sequentially delay the bias gate signals GB using at least one delay circuit connected in parallel to each bias gate line GBL. The gate driver 610 may invert the phases of the bias gate signals GB that are sequentially delayed using at least one inversion gate circuit connected in series to each delay circuit, and output the bias gate signals GB as initialization gate signals SGB′ of which phases are inverted to the initialization gate lines SGL.

The gate driver 610 may invert phases of the bias gate signals GB using at least one inverted gate circuit connected in parallel to each bias gate line GBL. The bias gate signals GB′ of which phases are inverted may be supplied to the inverted bias gate line GBL′ of the eighth transistor T8.

Referring to FIG. 16, the pixels PX of the display device 10 may operate in accordance with operation periods including a first period P1, a second period P2, a third period P3, a fourth period P4, a fifth period P5, and a sixth period P6. However, the operation order of pixels PX for each period will be replaced with the description of FIGS. 6 to 12.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A display device comprising:
a display panel in which a plurality of pixels are arranged in a display area to display an image; and
a gate driver supplying gate scan signals to the plurality of pixels in units of horizontal lines, wherein
the plurality of pixels include:
a first transistor connected between a driving voltage line and a second node;
a sixth transistor connected between the second node and a common voltage line;
a light emitting element connected between the sixth transistor and the common voltage line; and
a fourth transistor connected between the second node and an initialization voltage line, and
the gate driver generates another gate scan signal by delaying a phase of one of the gate scan signals, and supplies the another gate scan signal of which the phase is delayed to the plurality of pixels.

2. The display device of claim 1, wherein the plurality of pixels further include:
a second transistor connected between a data line and a first node;
a third transistor connected between a third node and the second node;
a fifth transistor connected between the driving voltage line and the first node;
a seventh transistor connected between a bias voltage line and the first node; and
an eighth transistor connected between an anode electrode of the light emitting element and a light emitting initialization line,
the first transistor is connected between the first node and the second node, and
a gate electrode of the first transistor is connected to the third node.

3. The display device of claim 2, wherein
the first transistor, the second transistor, the fourth transistor, the fifth transistor, the sixth transistor, the seventh transistor, and the eighth transistor are p-type transistors, and
the third transistor is an n-type transistor.

4. The display device of claim 2, wherein the plurality of pixels further include:
a write gate line connected to a gate electrode of the second transistor;
a compensation gate line connected to a gate electrode of the third transistor;
an initialization gate line connected to a gate electrode of the fourth transistor;
a light emitting line connected to gate electrodes of the fifth transistor and the sixth transistor;
a bias gate line connected to gate electrodes of the seventh transistor and the eighth transistor; and
a capacitor connected between the driving voltage line and the third node.

5. The display device of claim 4, wherein the gate driver:
transmits a write gate signal to the write gate line;
transmits a compensation gate signal to the compensation gate line;
transmits a bias gate signal to the bias gate line;
transmits a light emitting signal to the light emitting line; and
delays a phase of the bias gate signal for a period of time and supplies the bias gate signal of which the phase is delayed as an initialization gate signal to the initialization gate line.

6. The display device of claim 5, wherein the gate driver:
generates and transmits the compensation gate signal and the bias gate signal at an active level, in a first period among periods for driving the plurality of pixels;
transmits the initialization gate signal at an active level and the compensation gate signal at the active level, in a second period;
generates and transmits the compensation gate signal at the active level and the write gate signal at an active level, in a third period;
generates and transmits the bias gate signal at the active level, in a fourth period;
transmits the initialization gate signal at the active level, in a fifth period; and
generates and transmits the light emitting signal at an active level, in a sixth period.

7. The display device of claim 2, wherein
the first transistor, the second transistor, the fifth transistor, the sixth transistor, the seventh transistor, and the eighth transistor are p-type transistors, and
the third transistor and the fourth transistor are n-type transistors.

8. The display device of claim 7, wherein the plurality of pixels further include:
a write gate line connected to a gate electrode of the second transistor;
a compensation gate line connected to a gate electrode of the third transistor;
an initialization gate line connected to a gate electrode of the fourth transistor;
a light emitting line connected to gate electrodes of the fifth transistor and the sixth transistor;
a bias gate line connected to gate electrodes of the seventh transistor and the eighth transistor; and
a capacitor connected between the driving voltage line and the third node.

9. The display device of claim 8, wherein the gate driver:
transmits a write gate signal to the write gate line;
transmits a compensation gate signal to the compensation gate line;
transmits a bias gate signal to the bias gate line;
transmits a light emitting signal to the light emitting line; and
delays the bias gate signal for a period of time, inverts a phase of the bias gate signal of which is delayed, and supplies the bias gate signal of which is delayed and inverted as an initialization gate signal to the initialization gate line.

10. The display device of claim 2, wherein
the first transistor, the second transistor, the fifth transistor, the sixth transistor, and the seventh transistor are p-type transistors, and
the third transistor, the fourth transistor, and the eighth transistor are n-type transistors.

11. The display device of claim 10, wherein the plurality of pixels further include:
a write gate line connected to a gate electrode of the second transistor;
a compensation gate line connected to a gate electrode of the third transistor;
an initialization gate line connected to a gate electrode of the fourth transistor;
a light emitting line connected to gate electrodes of the fifth transistor and the sixth transistor;
a bias gate line connected to a gate electrode of the seventh transistor;
an inverted bias gate line connected to a gate electrode of the eighth transistor; and
a capacitor connected between the driving voltage line and the third node.

12. The display device of claim 11, wherein the gate driver:
transmits a write gate signal to the write gate line;
transmits a compensation gate signal to the compensation gate line;
transmits a bias gate signal to the bias gate line;
transmits a light emitting signal to the light emitting line;
inverts a phase of the bias gate signal and transmits the bias gate signal to the inverted bias gate line; and
delays the bias gate signal for a period of time, inverts a phase of the bias gate signal of which is delayed, and supplies the bias gate signal of which is delayed and inverted as an initialization gate signal to the initialization gate line.

13. A display device comprising:
a display panel in which a plurality of pixels are arranged in a display area to display an image; and
a gate driver supplying gate scan signals to the plurality of pixels in units of horizontal lines, wherein
the gate driver generates another gate scan signal by delaying a phase of one of the gate scan signals, and supplies the another gate scan signal of which the phase is delayed to the plurality of pixels, and
the plurality of pixels include:
a first transistor connected between a driving voltage line and a second node;
a second transistor connected between a data line and a first node;
a third transistor connected between a third node and the second node;
a fourth transistor connected between the second node and an initialization voltage line;
a fifth transistor connected between the driving voltage line and the first node;
a sixth transistor connected between the second node and a common voltage line;
a seventh transistor connected between a bias voltage line and the first node;
an eighth transistor connected between an anode electrode of a light emitting element and a light emitting initialization line; and
the light emitting element connected between the sixth transistor and the common voltage line.

14. The display device of claim 13, wherein the plurality of pixels further include:
a write gate line connected to a gate electrode of the second transistor;
a compensation gate line connected to a gate electrode of the third transistor;
an initialization gate line connected to a gate electrode of the fourth transistor;
a light emitting line connected to gate electrodes of the fifth transistor and the sixth transistor;
a bias gate line connected to gate electrodes of the seventh transistor and the eighth transistor; and
a capacitor connected between the driving voltage line and the third node.

15. The display device of claim 14, wherein the gate driver
transmits a write gate signal to the write gate line;
transmits a compensation gate signal to the compensation gate line;
transmits a bias gate signal to the bias gate line;
transmits a light emitting signal to the light emitting line; and
delays a phase of the bias gate signal for a period of time and supplies the bias gate signal as an initialization gate signal to the initialization gate line.

16. The display device of claim 14, wherein the gate driver
transmits a write gate signal to the write gate line;
transmits a compensation gate signal to the compensation gate line;
transmits a bias gate signal to the bias gate line;
transmits a light emitting signal to the light emitting line; and
delays the bias gate signal for a period of time, inverts a phase of the bias gate signal of which is delayed, and supplies the bias gate signal of which is delayed and inverted as an initialization gate signal to the initialization gate line.

17. The display device of claim 13, wherein the plurality of pixels further include:
a write gate line connected to a gate electrode of the second transistor;
a compensation gate line connected to a gate electrode of the third transistor;
an initialization gate line connected to a gate electrode of the fourth transistor;
a light emitting line connected to gate electrodes of the fifth transistor and the sixth transistor;
a bias gate line connected to a gate electrode of the seventh transistor;
an inverted bias gate line connected to a gate electrode of the eighth transistor; and
a capacitor connected between the driving voltage line and the third node.

18. The display device of claim 17, wherein the gate driver
transmits a write gate signal to the write gate line;
transmits a compensation gate signal to the compensation gate line;
transmits a bias gate signal to the bias gate line;
transmits a light emitting signal to the light emitting line; and
inverts a phase of the bias gate signal and transmits the bias gate signal to the inverted bias gate line; and
delays the bias gate signal for a period of time, inverts a phase of the bias gate signal of which is delayed, and supplies the bias gate signal of which is delayed and inverted as an initialization gate signal to the initialization gate line.

19. An electronic device including a display device, the electronic device comprising:
a display panel in which a plurality of pixels are arranged in a display area to display an image; and
a gate driver supplying gate scan signals to the plurality of pixels in units of horizontal lines, wherein
the plurality of pixels include:
a first transistor connected between a driving voltage line and a second node;
a sixth transistor connected between the second node and a common voltage line;
a light emitting element connected between the sixth transistor and the common voltage line; and
a fourth transistor connected between the second node and an initialization voltage line, and
the gate driver generates another gate scan signal by delaying a phase of one of the gate scan signals, and supplies the another gate scan signal of which the phase is delayed to the plurality of pixels.
